(19) United States
(12) Patent Application Publication
(10) Pub. No.: US 2014/0138006 A1
(43) Pub. Date: May 22, 2014

(54) PNEUMATIC TIRE AND MANUFACTURING METHOD OF THE SAME

(71) Applicant: TOYO TIRE & RUBBER CO., LTD., Osaka (JP)

(72) Inventor: Yuji Inoue, Osaka-shi (JP)

(73) Assignee: TOYO TIRE & RUBBER CO., LTD., Osaka (JP)

(21) Appl. No.: 14/056,358

(22) Filed: Oct. 17, 2013

(30) Foreign Application Priority Data
Nov. 22, 2012 (JP) 2012-256677
Nov. 22, 2012 (JP) 2012-256680

(51) Int. Cl. B60C 11/00; B29D 30/08

(52) U.S. Cl. CPC B60C 11/0008; B29D 30/08
USPC 152/526; 156/117

(57) ABSTRACT

The invention provides a pneumatic tire which suppresses one-sided flow of a tire caused by ply steer without deteriorating uniformity. A tread rubber is formed by a ribbon rubber which is wound around a tire rotating axis continuously from a winding start end to a winding terminal end. Positions of the winding start end and the winding terminal end are different from each other in a tire width direction. In the case that a belt incline side is set to a side in which a cord of a belt ply in the outermost side in a tire diametrical direction among a plurality of belt plies is inclined to a tire peripheral direction, the ribbon rubber is wound in a posture in which the ribbon rubber is inclined to an opposite side to the belt incline side in relation to the tire peripheral direction.

### BACKGROUND OF THE INVENTION

1. Field of the Invention

The present invention relates to a pneumatic tire having a tread rubber, and a manufacturing method of the same.

2. Description of the Related Art

Conventionally, there has been proposed a so-called ribbon winding construction method which forms a tread rubber by spirally winding an unvulcanized ribbon rubber around a tire rotating axis to an outer peripheral surface of an approximately cylindrical rotation support body, while overlapping a side edge thereof.

As one example of a pneumatic tire in which the tread rubber is formed by the ribbon winding construction method, for example, JP-A-2006-130880 discloses a pneumatic tire structured such that a ribbon rubber is wound from a starting point which is positioned in a center portion of a tread toward one side in a tire width direction in a tire meridian cross section, is next folded back to the other side in the tire width direction in a tread end on the one side, and is wound toward a tread end on the other side beyond the starting point, and a winding start end and a winding terminal end of the ribbon rubber are arranged in a center portion of the tread rubber (in the vicinity of a tire equator).

### SUMMARY OF THE INVENTION

However, in the pneumatic tire according to JP-A-2006-130880, since the winding start end and the winding terminal end of the ribbon rubber are both arranged in the tread center, and the winding start end and the winding terminal end of the ribbon rubber are in an overlapping positional relationship as seen from a tire diametrical direction, the structure is not good in the light of a uniformity.

Further, in a general tire which is provided with a belt layer constructed by a plurality of belt plies having cords which are inclined to a tire peripheral direction, force called as ply steer is generated by extension and contraction of the cord of the belt ply in the outermost side in the diametrical direction. Since the ply steer causes a one-sided flow of the tire in conjunction with a rolling motion, the ply steer is preferably as small as possible.

The present invention is made by paying attention to the problem mentioned above, and an object of the present invention is to provide a pneumatic tire which suppresses a one-sided flow of the tire caused by the ply steer without deteriorating the uniformity, and a manufacturing method of the same.

The present invention employs the following means for achieving the object.

In other words, according to the present invention, there is provided a pneumatic tire including a belt layer which is provided in a tread portion and is constructed by a plurality of belt plies having cords which are inclined to a tire peripheral direction; and a tread rubber which is arranged in an outer side in a tire diametrical direction of the belt layer in the tread portion, wherein the tread rubber is formed by a ribbon rubber which is wound around a tire rotating axis continuously from a winding start end to a winding terminal end, wherein positions of the winding start end and the winding terminal end are different from each other in a tire width direction, and wherein in a case that a belt incline side is set to a side in which the cord of the belt ply in the outermost side in the tire diametrical direction among the plurality of belt plies is inclined to the tire peripheral direction, at least a part of the ribbon rubber is wound in a posture in which the part is inclined to an opposite side to the belt incline side in relation to the tire peripheral direction.

As mentioned above, since at least a part of the ribbon rubber is wound in the posture in which the part is inclined to the opposite side to the belt incline side in relation to the tire peripheral direction, the force is generated in the direction of cancelling the ply steer, on the basis of the winding posture of the ribbon rubber, and it is possible to suppress the one-sided flow of the tire caused by the ply steer. Further, since the winding start end and the winding terminal end are different in their positions in the tire width direction, the structure is preferable in the light of the uniformity.

In order to further reduce the ply steer, it is preferable that the cord of the belt ply in the outermost side in the tire diametrical direction extends from one side in the tire width direction to the other side in the tire width direction as the cord heads for an advance side from a delay side in the tire rotating direction, the ribbon rubber is wound so that a winding density is higher in the one side in the tire width direction than in the other side in the tire width direction.

In order to make easy to manufacture the tire having the difference in the winding density, is it preferable that the ribbon rubber is wound from a start point which is positioned at a tread end portion in the other side in the tire width direction toward the one side in the tire width direction, is next folded back to the other side in the tire width direction at a tread end in the one side in the tire width direction so as to be wound toward a tread end in the other side in the tire width direction, and is next folded back to the one side in the tire width direction at the tread end in the other side so as to be wound to an end point which is positioned in a tread center portion, whereby the one side in the tire width direction of the tread rubber is formed as a double layer structure, and the other side in the tire width direction of the tread rubber is formed as a triple layer structure.

The tread center portion means a range which is within 10% the maximum width of the belt ply in the outermost side in the tire diametrical direction, from a tire equator toward an outer side in the tire width direction. Further, tread end portions mean a range which is within 20% the tread rubber maximum width from tread ends toward a center side.

In order to further suppress the one-side flow of the tire caused by the ply steer, it is preferable that the ribbon rubber is spirally wound over a whole area in the tire peripheral direction in a posture in which the ribbon rubber is inclined to an opposite side to the belt incline side in relation to the tire peripheral direction.

The pneumatic tire mentioned above is manufactured by a manufacturing method described below. In other words, according to the present invention, there is provided a manufacturing method of a pneumatic tire, including a belt layer which is provided in a tread portion and is constructed by a plurality of belt plies having cords which are inclined to a tire peripheral direction, and a tread rubber which is arranged in an outer side in a tire diametrical direction of the belt layer in the tread portion, the method including a tread rubber forming step of forming the tread rubber by winding a ribbon rubber around a tire rotating axis continuously from a winding start end to a winding terminal end, wherein the tread rubber forming step differentiates positions of the winding start end and the winding terminal end from each other in a tire width direction, and wherein in a case that a belt incline side is set to a side in which the cord of the belt ply in the outermost side in the tire diametrical direction among the plurality of belt plies is inclined to the tire peripheral direction, the method winds at least a part of the ribbon rubber in a posture in which the part is inclined to an opposite side to the belt incline side in relation to the tire peripheral direction.

According to the manufacturing method mentioned above, it is possible to produce the same action effect as the above.

Further, according to the present invention, in the above-mentioned pneumatic tire, the winding start end is positioned in a tread center position and the winding terminal end is positioned in a tread end portion, whereby positions of the winding start end and the winding terminal end are different from each other in a tire width direction.

According to the structure, since the winding terminal end is positioned in the tread end portion, the uniformity, for example, the radial runout (PRO) and the radial force variation (RFV) is improved in comparison with the case that the winding terminal end is provided in the tread center portion, and it is possible to improve the high-speed durability.

In order to make easy to manufacture the tire having the difference in the winding density, is it preferable that the ribbon rubber is wound from a start point which is positioned in a tread center portion toward the other side in the tire width direction, is next folded back to the one side in the tire width direction at a tread end in the other side in the tire width direction so as to be wound toward a tread end in the one side in the tire width direction, and is terminated at the tread end portion in any of the one side in the tire width direction and the other side in the tire width direction, whereby the one side in the tire width direction of the tread rubber is formed as an N-th layer structure (N is a natural number which is equal to or more than 1) , and the other side in the tire width direction of the tread rubber is formed as an (N+1)th layer structure.

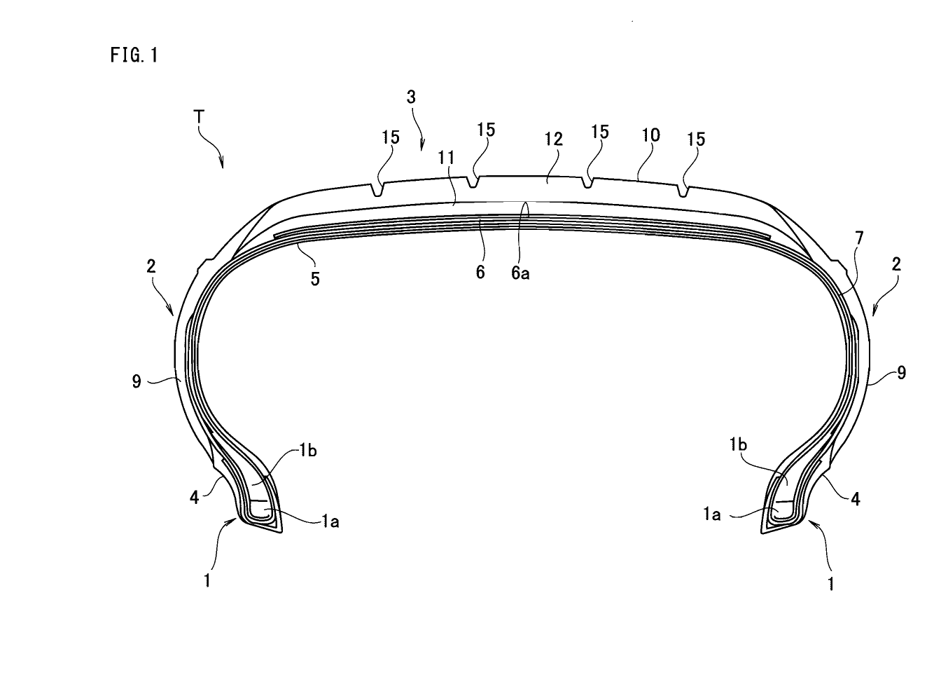

FIG. 1 is a tire meridian cross sectional view showing a pneumatic tire according to a first embodiment of the present invention;

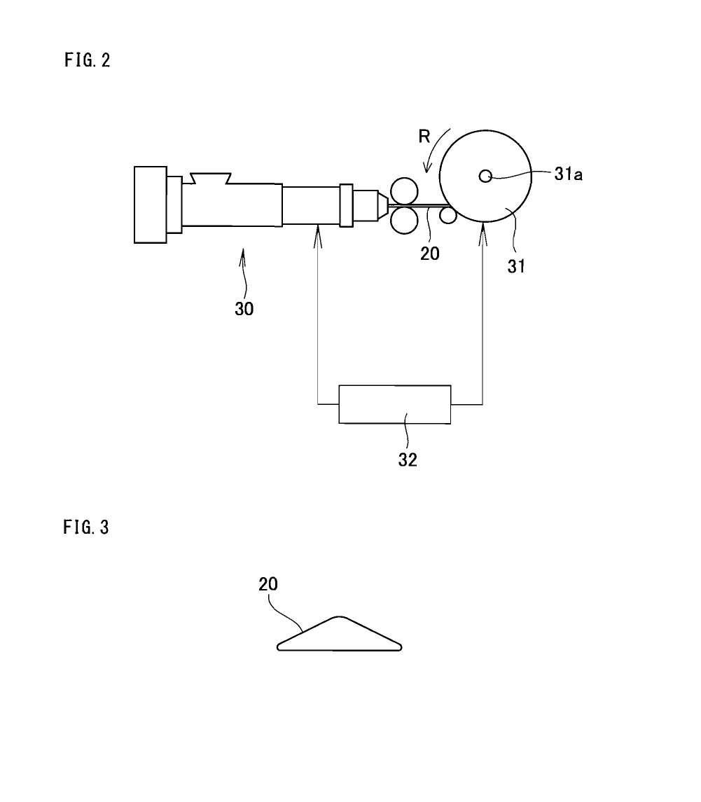

FIG. 2 is a view showing a manufacturing facility which is used in a forming step of a tread rubber;

FIG. 3 is a schematic cross sectional view of a ribbon rubber;

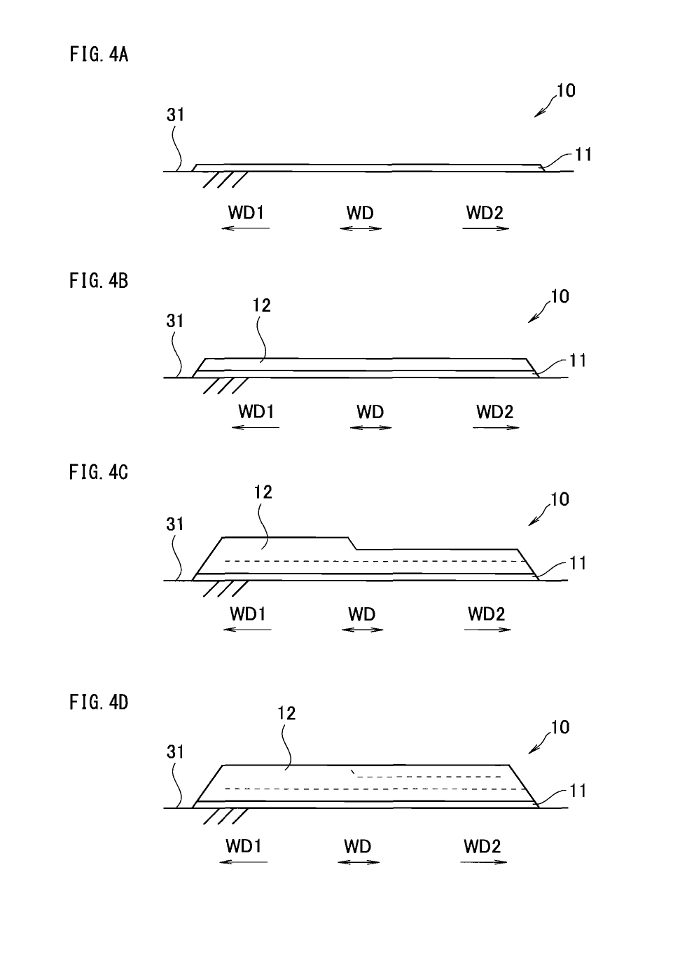

FIG. 4A is a cross sectional view schematically showing the forming step of the tread rubber according to the first embodiment;

FIG. 4B is a cross sectional view schematically showing the forming step of the tread rubber according to the first embodiment;

FIG. 4C is a cross sectional view schematically showing the forming step of the tread rubber according to the first embodiment;

FIG. 4D is a cross sectional view schematically showing the forming step of the tread rubber according to the first embodiment;

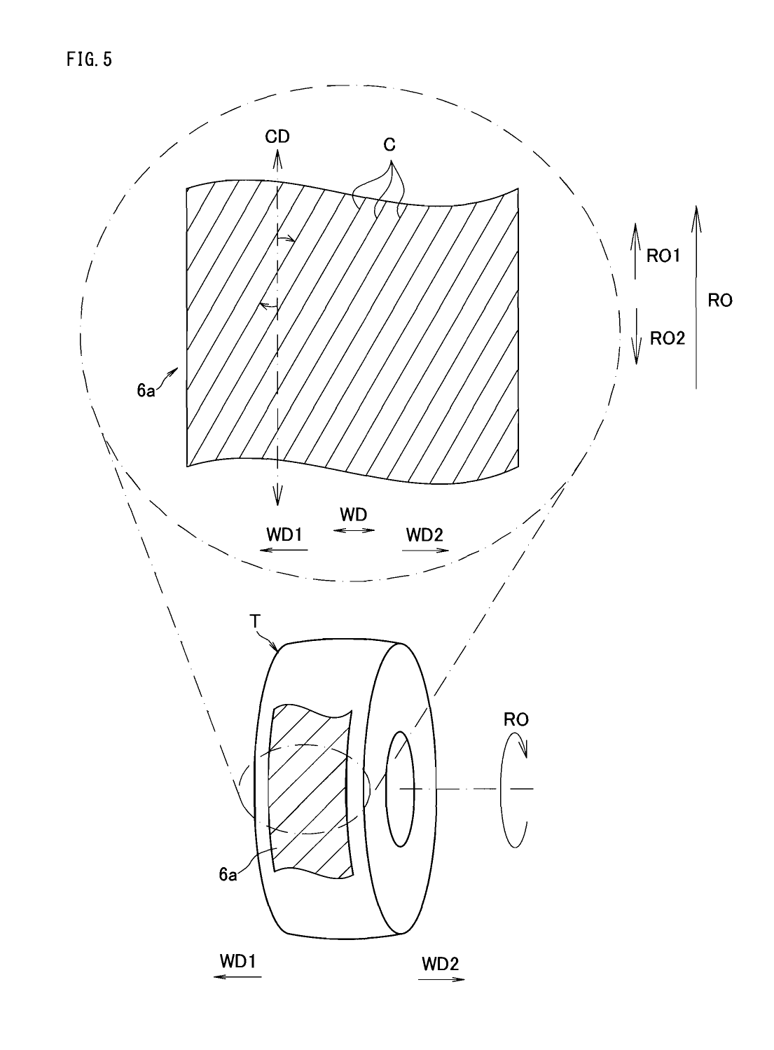

FIG. 5 is a view schematically showing a relationship between an inclined posture of a cord in a second belt ply in the outermost side in a tire diametrical direction, and a tire rotating direction;

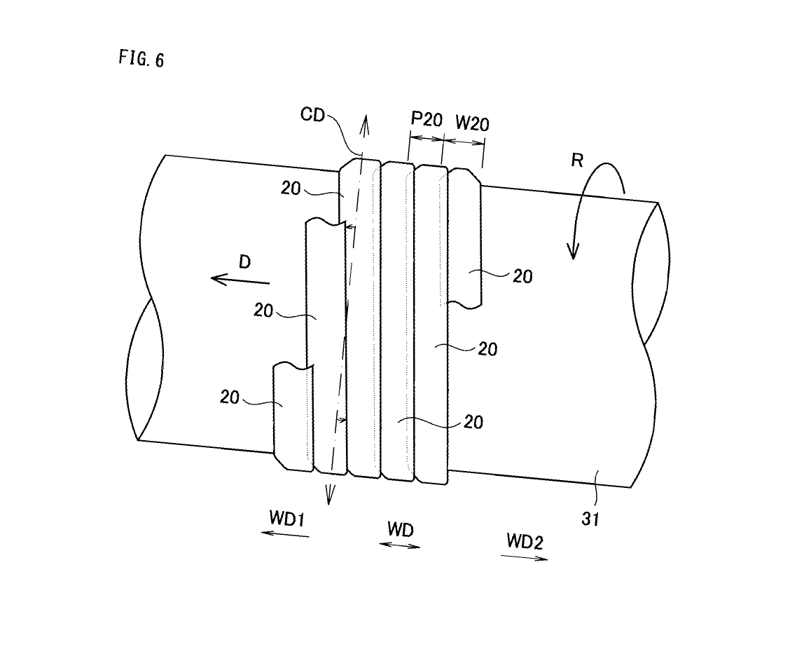

FIG. 6 is a plan view showing a winding process of the ribbon rubber;

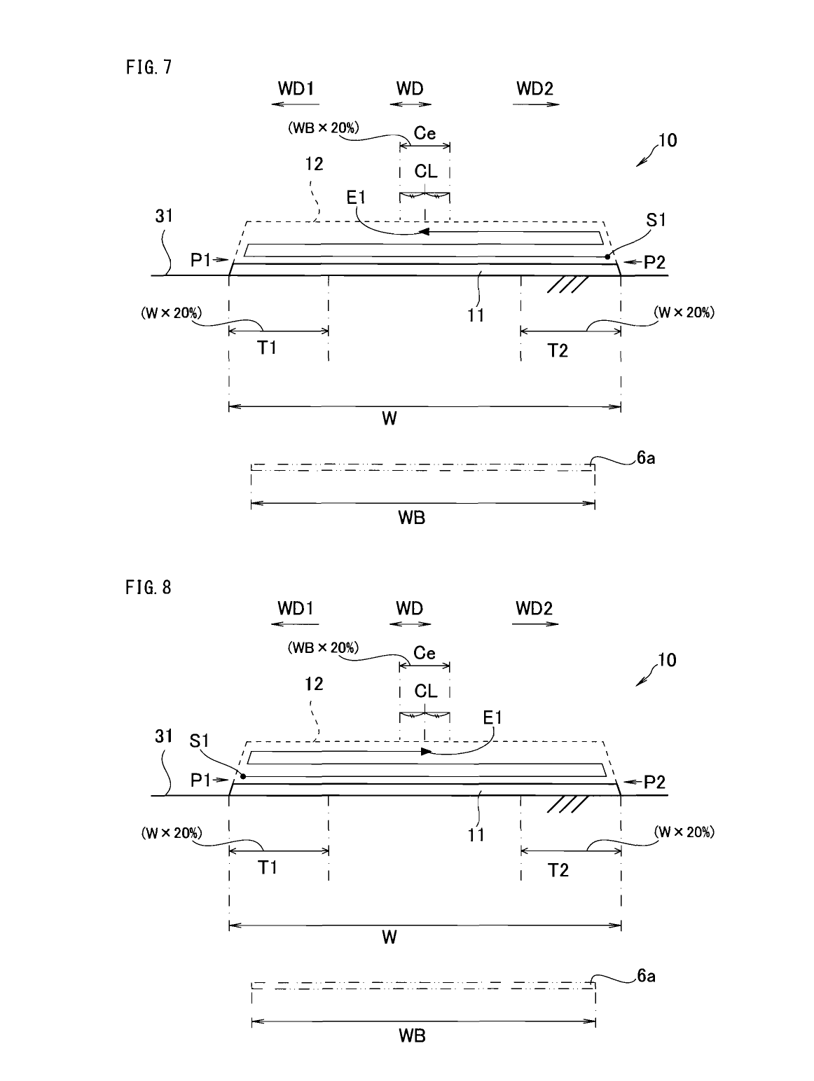

FIG. 7 is a conceptual view showing a moving route of a ribbon winding position according to the first embodiment;

FIG. 8 is a conceptual view showing a moving route of a ribbon winding position according to a modified example of the first embodiment;

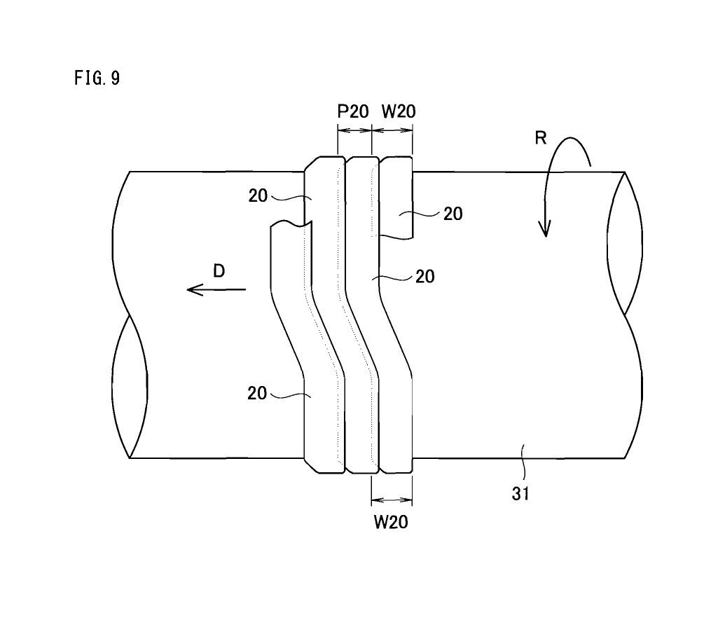

FIG. 9 is a plan view showing a winding process of a ribbon rubber according to the other modified example than the above of the first embodiment;

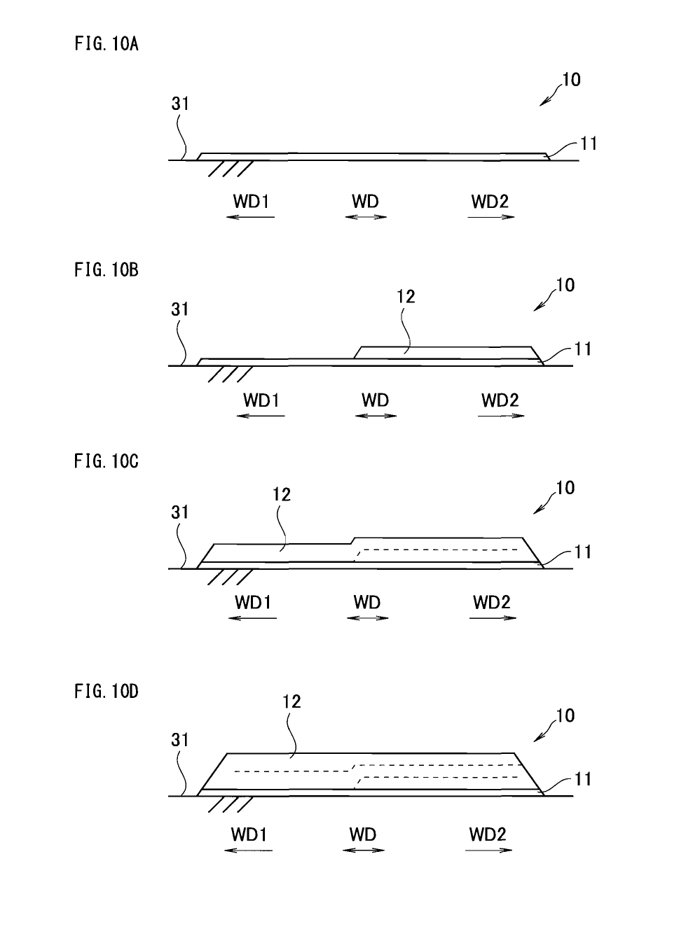

FIG. 10A is a cross sectional view schematically showing a forming step of a tread rubber according to a second embodiment;

FIG. 10B is a cross sectional view schematically showing the forming step of the tread rubber according to the second embodiment;

FIG. 10C is a cross sectional view schematically showing the forming step of the tread rubber according to the second embodiment;

FIG. 10D is a cross sectional view schematically showing the forming step of the tread rubber according to the second embodiment;

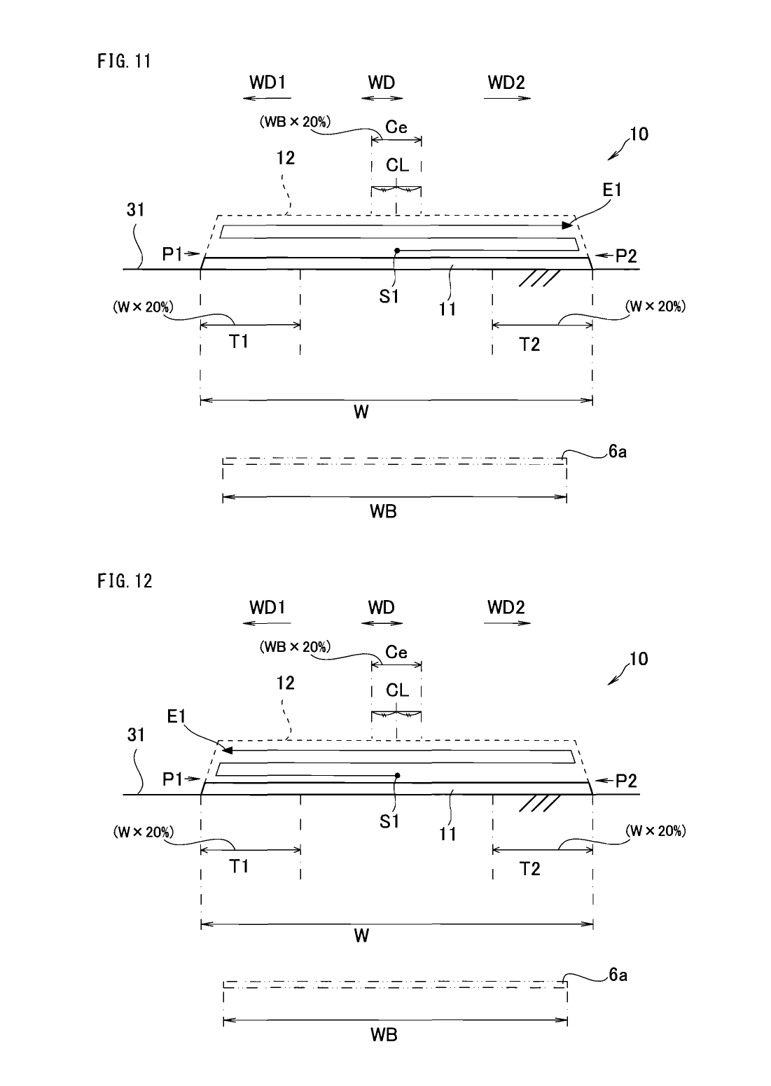

FIG. 11 is a conceptual view showing a moving route of a ribbon winding position according to the second embodiment;

FIG. 12 is a conceptual view showing a moving route of a ribbon winding position according to a modified example of the second embodiment; and

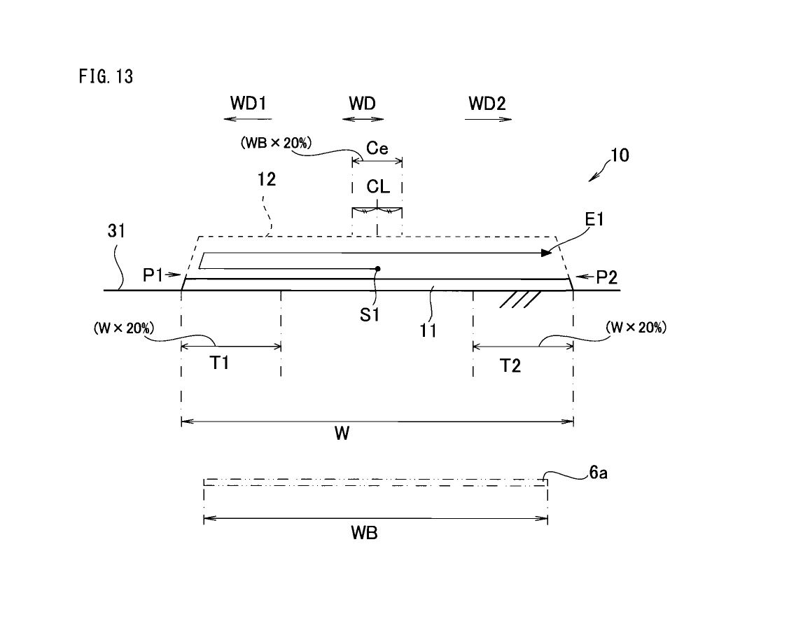

FIG. 13 is a plan view showing a winding process of a ribbon rubber according to the other modified example than the above of the second embodiment.

### DETAILED DESCRIPTION OF THE PREFERRED EMBODIMENTS

### First Embodiment

A pneumatic tire according to a first embodiment of the present invention will be described blow with reference to the accompanying drawings. First of all, a description will be given of a structure of a pneumatic tire according to the present invention, and a description will be given next of a manufacturing method of the pneumatic tire according to the present invention.

[Structure of Pneumatic Tire]

A pneumatic tire T shown in FIG. 1 is provided with a pair of bead portions 1, side wall portions 2 each of which extends to an outer side in a tire diametrical direction from each of the bead portions 1, and a tread portion 3 which is connected to an outer end in the tire diametrical direction of each of the side wall portions 2. An annular bead core 1a formed by coating a converged body of steel wires with a rubber, and a bead filler 1b made of a hard rubber are arranged in the bead portion 1.

A toroidal carcass layer 7 is arranged between a pair of bead portions 1, and an end portion thereof is locked in a state of being wound up via the bead core 1a. The carcass layer 7 is constructed by at least one (two in the present embodiment) carcass ply, and the carcass ply is formed by coating a cord extending at an angle of about 90 degrees with respect to the tire peripheral direction with a topping rubber. An inner liner rubber 5 for retaining a pneumatic pressure is arranged in an inner periphery of the carcass layer 7.

The bead portion 1 is provided on an outer side of the carcass layer 7 with a rim strip rubber 4 which comes into contact with a rim (not shown) at the time of installation of the rim. Further, the side wall portion 2 is provided on the outer side of the carcass layer 7 with a side wall rubber 9. In the present embodiment, each of the rim strip rubber 4 and the side wall rubber 9 is formed by a conductive rubber.

In the tread portion 3, a belt layer 6 constructed by a plurality of (two in the present embodiment) belt plies is arranged on the outer side of the carcass layer 7. Each of the belt plies is formed by coating a cord which extends while inclining with respect to the tire peripheral direction with a topping rubber, and is laminated in such a manner that the cord intersect inversely to each other between the plies. In the present embodiment, the belt ply in an inner side in the diametrical direction among a plurality of belt plies is called as a first belt ply, and the belt ply in the outermost side in the tire diametrical direction is called as a second belt ply 6a.

In the tread portion 3, a tread rubber 10 is provided in outer periphery of the belt layer 6. The tread rubber 10 has a cap portion 12 which constructs a ground plane, and a base portion 11 which is provided on an inner side in the tire diametrical direction of the cap portion 12. The base 11 is made of a different kind of rubber from the cap 12.

As a raw material rubber of the rubber layer mentioned above, there can be listed up a natural rubber, a styrene butadiene rubber (SBR), a butadiene rubber (BR), an isoprene rubber (IR), an isobutylene isoprene rubber (IIR) and the like, and they are used independently or are used by mixing two or more. Further, the rubbers are reinforced by a filler such as a carbon black or a silica, and are appropriately blended with a vulcanizing agent, a vulcanization accelerator, a plasticizer, an antioxidant or the like.

The tread rubber 10, particularly the cap portion 12 is formed by a so-called ribbon winding construction method. The ribbon winding construction method is a construction method for forming a rubber member having a desired cross sectional shape by spirally winding a narrow and unvulcanized ribbon rubber 20 shown in FIG. 3 around a tire rotating axis (refer to FIG. 2 and FIG. 5). The tread rubber 10 formed by the ribbon winding construction method has a winding start end S1 and a winding terminal end E1 of the ribbon rubber 20, as shown in FIG. 7C. The winding start end S1, the winding terminal end E1 and a moving route of a winding position can be checked out in a tire meridian cross section. Details thereof will be mentioned later.

Further, with a vulcanizing treatment being applied, a main groove 15 extending in the tire peripheral direction is formed on a surface of the tread rubber 10. A projection is provided in a tire mold which is used for the vulcanizing treatment, and the main groove 15 is formed by pressing the projection against the tread rubber 10. Thought an illustration will be omitted, the tread rubber 10 is appropriately provided with a transverse groove which extends in a direction intersecting the main groove 15.

[Manufacturing Method of Pneumatic Tire]

Next, a description will be given of a method of manufacturing the pneumatic tire T. Since the pneumatic tire T can be manufactured in the same manner as the conventional tire manufacturing method, except a point relating to the tread rubber 10, a description will be given mainly of a forming step of the tread rubber 10.

The tread rubber 10 shown in FIG. 1 is formed by the ribbon winding construction method. A forming step of the tread rubber 10 includes a stage which winds the ribbon rubber 20 supplied from a ribbon rubber forming device 30 to a rotation support body 31, while rotating the rotation support body 31, as shown in FIG. 2. The rubber ribbon 20 is formed by a nonconductive rubber, as shown in FIG. 3. A lower side in FIG. 3 comes to an inner peripheral side which is opposed to the rotation support body 31, at the winding time. A width and a thickness of the ribbon rubber (which may be called as a rubber strip) are not particularly limited, however, are preferably desirable to be set between 15 and 40 mm in width and between 0.5 to 3.0 mm in thickness.

As shown in FIG. 2, the ribbon rubber forming device 30 is structured so as to form the ribbon rubber 20 by extruding the rubber. The rotation support body 31 is structured so as to achieve a rotation in a direction R around an axis 31a, and a movement in an axial direction. A control device 32 carries out the operation control of the ribbon rubber forming device 30 and the rotation support body 31. In the present embodiment, a cross section of the ribbon rubber 20 is formed as a triangular shape, however, is not limited to this, but may be formed as the other shapes such as an oval shape, a quadrangular shape and the like. Further, the rotation support body 31 is structured so as to move in the axial direction, however, the ribbon rubber forming device 30 may be moved with respect to the rotation support body 31. In other words, it is possible to employ any structure as long as the rotation support body 31 can move relatively along the axis direction with respect to the ribbon rubber forming device 30.

In the forming step of the tread rubber 10, first of all, as shown in FIG. 4A, the base portion 11 is formed in an outer peripheral surface of the rotation support body 31. Though an illustration will be omitted, the belt layer 6 is provided previously on an outer peripheral surface of the rotation support body 31 (refer to FIG. 1), and the base portion 11 is formed on them. The base portion 11 may be formed by any one of a so-called extrusion molding method and the ribbon winding construction method. The extrusion molding method is a construction method which has a step of extruding and molding an unvulcanized band-like rubber member having a desired cross sectional shape, and jointing end portions thereof so as to form annularly.

Here, as a matter of convenience for description, one side (a left side in the drawing) in a tire width direction WD is set to WD1, and the other side is set to WD2 (a right side in the drawing), in the tire meridian cross section.

Next, as sequentially shown in FIGS. 4B, 4C and 4D, the cap portion 12 is formed in the outer peripheral surface of the base 11, and the tread rubber 10 shown in FIG. 1 is formed. FIG. 5 shows a state of the belt ply 6a (the second belt ply in the present embodiment) which is provided in the outermost side in the tire diametrical direction among a plurality of belt plies, and the cord C of the belt ply 6a. In this case, the force called as the ply steer is generated from the one side WD1 in the tire width direction toward the other side WD2 in the tire width direction in conjunction with the rotation of the tire. As shown in the drawing, on the assumption that a belt incline side is a side in which the cord C of the second belt ply 6a is inclined to the tire peripheral direction CD, the ribbon rubber 20 is wound in a posture in which the ribbon rubber is inclined in an opposite side to the belt incline side in relation to the tire peripheral direction CD, as shown in FIG. 6. According to an inclined posture of the ribbon rubber 20 as mentioned above, the force is generated in a direction of cancelling the ply steer.

As shown in FIG. 6, a winding pitch P20 of the ribbon rubber 20 is set to be smaller than a ribbon width W20 of the ribbon rubber 20. As a result, the adjacent ribbon rubbers 20 and 20 are spirally wound in a state in which the adjacent ribbon rubbers are in contact with each other. An arrow D indicates a moving direction of the ribbon winding position, and the adjacent ribbon rubbers 20 overlap their edge portions with each other along the direction.

In the present embodiment, as shown in FIG. 6, the ribbon rubber 20 is spirally wound over a whole area in the tire peripheral direction CD in the posture in which the ribbon rubber is inclined to the opposite side to the belt incline side in relation to the tire peripheral direction CD, however, is not limited to this. For example, there can be listed up a so-called pitch feed winding. The pitch feed winding is a winding way of moving the winding position of the ribbon rubber 20 in a posture in which the ribbon rubber 20 is inclined to the opposite side to the belt incline side in relation to the tire peripheral direction CD every time that the ribbon rubber 20 is wound one circle along the tire peripheral direction CD, as shown in FIG. 9. In the spiral winding, approximately all the ribbon rubber 20 is wound in a posture in which the ribbon rubber is inclined to the tire peripheral direction CD, as shown in FIG. 6. On the other hand, in the pitch feed winding, only a part of the ribbon rubber 20 is wound in a posture in which the ribbon rubber 20 is inclined to the tire peripheral direction CD.

In the present embodiment, as shown in FIG. 5, there is listed up the example in which the cord C of the belt ply 6a rises rightward, however, in the case that the cord C rises leftward, the inclined posture of the ribbon rubber is reversed.

The winding pitch P20 of the ribbon rubber 20 may be uniform all the area in the tire width direction WD, however, in order to further reduce the ply steer, the winding pitch P20 is preferably different between the one side WD1 in the tire width direction and the other side WD2 in the tire width direction. Specifically, as shown in FIG. 5, in the tire T in which a rotating direction RO is designated (the tire in which a rotating direction or an installing direction to the vehicle is displayed on an outer surface, for example, a tire side), in the case that the cord C of the belt ply 6a in the outermost side in the tire diametrical direction extends from the one side WD1 in the tire width direction to the other side WD2 in the tire width direction as the cord C heads for an advance side RO1 from a delay side RO2 in the tire rotating direction RO, the ribbon rubber 20 is wound so that a winding density is higher in the one side WD1 in the tire width direction than in the other side WD2 in the tire width direction. The winding density becomes higher by making the winding pitch P20 of the ribbon rubber 20 smaller, and becomes lower by making the winding pitch P20 larger, in the case that the thickness of the ribbon rubber 20 is constant. According to the structure, force called as conicity heading for the one side WD1 in the tire width direction having the higher density from the other side WD2 in the tire width direction having the lower density is generated in the direction of cancelling the ply steer.

FIG. 7 conceptually shows a moving route of the winding position of the ribbon rubber 20 in the forming step of the tread rubber shown in FIGS. 4A to 4D. The ribbon rubber is wound from a start point S1 which is positioned in the tread end portion T2 in the other side WD2 in the tire width direction toward the one side WD1 in the tire width direction, in the tire meridian cross section. Next, the ribbon rubber folds back to the other side WD2 in the tire width direction at a tread end P1 in the one side WD1 in the tire width direction, and is wound toward a tread end P2 in the other side WD2 in the tire width direction. Next, the ribbon rubber folds back to the one side WD1 in the tire width direction at the tread end P2 in the other side WD2 in the tire width direction, and is wound toward an end point E1 which is positioned in the tread center portion Ce. According to the winding way mentioned above, a double layer structure is formed in the one side WD1 in the tire width direction of the tread rubber 10, and a triple layer structure is formed in the other side WD2 in the tire width direction of the tread rubber 10. Therefore, a structure which is different in a winding density between the one side WD1 and the other side WD2 in the tire width direction is obtained by adjusting the pitch so that the thickness of the tread rubber 10 is constant, and can be easily manufactured.

As shown in FIG. 7, the tread center portion Ce means a range which is within 10% the maximum width WB of the belt ply 6a in the outermost side in the tire diametrical direction, from a tire equator CL toward an outer side in the tire width direction. Further, tread end portions T1 and T2 mean a range which is within 20% the tread rubber maximum width W from tread ends P1 and P2 toward a center side. A winding start end S1 and a winding terminal end E1 of the ribbon rubber are arranged so as to be different in their positions in the tire width direction WD.

Further, the winding start end S1 and the winding terminal end E1 are preferably arranged in a positional relationship in which the winding start end S1 and the winding terminal end E1 are away at 180 degree in the tire peripheral direction, and are symmetrical around the tire rotating axis as seen from the tire rotating axis.

Further, the winding terminal end E1 is preferably arranged at a position in which the main grove 15 extending in the tire peripheral direction CD is formed. Specifically, there can be listed up a structure in which the winding terminal end E1 is arranged in an inner side in the tire diametrical direction of the main groove 15 in the tire meridian cross section.

As mentioned above, the pneumatic tire according to the present embodiment is provided with the belt layer 6 which is provided in the tread portion 3 and is constructed by a plurality of belt plies having the cords which are inclined to the tire peripheral direction CD, and the tread rubber 10 which is arranged in the outer side in the tire diametrical direction of the belt layer 6 in the tread portion 3, the tread rubber 10 is formed by the ribbon rubber 20 which is wound around the tire rotating axis continuously from the winding start end S1 to the winding terminal end E1, the winding start end S1 and the winding terminal end E1 are different from each other in their positions in the tire width direction, and at least a part of the ribbon rubber 20 is wound in the posture in which the part is inclined to the opposite side to the belt incline side in relation to the tire peripheral direction CD, in the case that the belt incline side is set to the side in which the cord C of the belt ply 6a in the outermost side in the tire diametrical direction among a plurality of belt plies is inclined to the tire peripheral direction CD.

Further, the pneumatic tire according to the present embodiment is produced by the following manufacturing method. In other words, the manufacturing method of the pneumatic tire according to the present embodiment is the manufacturing method of the pneumatic tire provided with the belt layer 6 which is provided in the tread portion 3 and is constructed by a plurality of belt plies having the cords which are inclined to the tire peripheral direction CD, and the tread rubber 10 which is arranged in the outer side in the tire diametrical direction of the belt layer 6 in the tread portion 3, the method has the tread rubber forming step of forming the tread rubber 10 by winding the ribbon rubber 20 around the tire rotating axis continuously from the winding start end S1 to the winding terminal end E1, the winding start end S1 and the winding terminal end E1 are differentiated their positions in the tire width direction WD in the tread rubber forming step, and at least a part of the ribbon rubber 20 is wound in the posture in which the part is inclined to the opposite side to the belt incline side in relation to the tire peripheral direction CD in the case that the belt incline side is set to the side in which the cord C of the belt ply 6a in the outermost side in the tire diametrical direction among a plurality of belt plies is inclined to the tire peripheral direction CD.

As mentioned above, since at least a part of the ribbon rubber is wound in the posture in which the part is inclined to the opposite side to the belt incline side in relation to the tire peripheral direction, the force is generated in the direction of cancelling the ply steer, on the basis of the winding posture of the ribbon rubber, and it is possible to suppress the one-sided flow of the tire caused by the ply steer. Further, since the winding start end S1 and the winding terminal end E1 are different in their positions in the tire width direction WD, the structure is preferable in the light of the uniformity.

Particularly, in the present embodiment, in the case that the cord C of the belt ply 6a in the outermost side in the tire diametrical direction extends from the one side WD1 in the tire width direction to the other side WD2 in the tire width direction as the cord C heads for the advance side RO1 from the delay side RO2 in the tire rotating direction RO, the ribbon rubber 20 is wound so that the winding density is higher in the one side WD1 in the tire width direction than in the other side WD2 in the tire width direction.

According to the structure, the force called as the ply steer is generated from the one side WD1 in the tire width direction toward the other side WD2 in the tire width direction in conjunction with the tire rotation. However, since the winding density of the ribbon rubber 20 is higher in the one side WD1 in the tire width direction than in the other side WD2 in the tire width direction, the force called as the conicity is generated in the direction of cancelling the ply steer. Therefore, it is possible to further reduce the ply steer.

Further, in the present embodiment, the ribbon rubber 20 is wound from the start point S1 which is positioned in the tread end portion T2 in the other side WD2 in the tire width direction toward the one side WD1 in the tire width direction, is next folded back to the other side WD2 in the tire width direction at the tread end P1 in the one side WD1 in the tire width direction so as to be wound toward the tread end P2 in the other side WD2 in the tire width direction, and is next folded back to the one side WD1 in the tire width direction at the tread end P2 in the other side WD2 in the tire width direction so as to be wound to the end point E1 which is positioned in the tread center portion Ce. As a result, the one side WD1 in the tire width direction of the tread rubber 10 is formed as the double layer structure, and the other side WD2 in the tire width direction of the tread rubber 10 is formed as the triple layer structure.

According to the structure, it is possible to appropriately wind the ribbon rubber while differentiating the positions of the winding start end S1 and the winding terminal end E1 of the ribbon rubber 20 in the tire width direction WD. Further, it is possible to obtain the structure in which the winding density is differentiated between the one side WD1 and the other side WD2 in the tire width direction, by adjusting the pitch so that the thickness of the tread rubber 10 is constant, and the tire having the difference in the winding density can be easily manufactured.

Further, in the present embodiment, the ribbon rubber 20 is spirally wound over a whole area in the tire peripheral direction CD in the posture in which the ribbon rubber is inclined to the opposite side to the belt incline side in relation to the tire peripheral direction CD.

According to the structure, since the force of cancelling the ply steer becomes stronger in comparison with the pitch feed winding, it is possible to further suppress the one-side flow of the tire caused by the ply steer.

Further, in the present embodiment, the winding start end S1 and the winding terminal end E1 are away at 180 degrees in the tire peripheral direction, and are arranged in the positional relationship in which the winding start end S1 and the winding terminal end E1 are symmetrical around the tire rotating axis as seen from the tire rotating axis . According to the structure, since the uniformity, for example, a radial force variation (RFV) is improved, and a grounded pressure distribution on the periphery is uniform, it is possible to improve a high-speed durability.

Further, in the present embodiment, the winding terminal end E1 is arranged in the forming position of the main groove 15 which extends in the tire peripheral direction CD. Since the forming position of the main groove 15 is smaller in a rubber thickness and can suppress heat generation at the high-speed rotating time, it is possible to suppress failure caused by the heat generation, and it is possible to further improve the high-speed durability.

### Modified Example of First Embodiment

(1) The moving route of the winding position of the ribbon rubber 20 may be reversed laterally as shown in FIG. 8 in addition to that in FIG. 7.

(2) In the present embodiment, the nonconductive rubber is used for the ribbon rubber 20, however, a conductive rubber may be used, or a ribbon rubber obtained by overlapping the non-conductive rubber and the conductive rubber may be used.

Further, FIG. 2 shows the example which used one ribbon rubber forming device 30, however, a so-called two-shot type using a plurality of ribbon rubber forming devices 30 may be employed.

### Second Embodiment

A description will be given below of a pneumatic tire according to a second embodiment of the present invention with reference to the accompanying drawings. The same reference numerals are attached to the same members as those of the first embodiment, and a description thereof will be omitted.

FIGS. 10A to 10D are views corresponding to FIGS. 4A to 4D, and are cross sectional views schematically showing a forming step of a tread rubber according to the second embodiment.

FIG. 11 conceptually shows a moving route of a winding position of a ribbon rubber 20 in a forming step of the tread rubber shown in FIGS. 10A to 10D. The ribbon rubber is wound from a start point which is positioned in a tread center portion Ce toward the other side WD2 in a tire width direction, in a tire meridian cross section. Next, the ribbon rubber is folded back to one side WD1 in the tire width direction at a tread end P2 in the other side WD2 in the tire width direction, and is wound toward a tread end P1 in the one side WD1 in the tire width direction. Next, the ribbon rubber is folded back to the other side WD2 in the tire width direction at the tread end P1 in the one side WD1 in the tire width direction, and is terminated at an end point E1 which is positioned in a tread end portion T2 in the other side WD2 in the tire width direction. By winding as mentioned above, the one side WD1 in the tire width direction of the tread rubber 10 is formed as an N-th layer structure (N=2 in the present embodiment) , and the other side WD2 in the other side of the tread rubber 10 is formed as an (N+1)th layer structure. As a result, a structure which is differentiated in a winding density between the one side WD1 and the other side WD2 in the tire width direction is obtained by adjusting a winding pitch so that the thickness of the tread rubber 10 is constant, and it is possible to easily manufacture.

The winding terminal end E1 is arranged in the tread end portions T1 and T2, however, is preferably arranged in an outer side in the tire width direction than the grounded end. The grounded end is the outermost position in the tire width direction WD of the grounded surface. The grounded surface is a surface which is grounded on a road surface when the tire is rimmed in a normal rim and is vertically put on a flat road surface in a state in which the tire is filled with a normal internal pressure, and a normal load is applied. The normal rim is in principle a standard rim which is defined in JISD4202, and the normal load is a load which is 0.8 times the maximum load (a design normal load in the case of a tire for a passenger car) defined in JISD4202 (automotive tire data), and the normal internal pressure is a pneumatic pressure matching to the maximum load.

As mentioned above, the pneumatic tire of the present embodiment is the pneumatic tire including:

a belt layer 6 which is provided in a tread portion 3 and is constructed by a plurality of belt plies having cords which are inclined to a tire peripheral direction CD; and

a tread rubber 10 which is arranged in an outer side in a tire diametrical direction of the belt layer 6 in the tread portion 3,

wherein the tread rubber 10 is formed by a ribbon rubber 20 which is wound around a tire rotating axis continuously from a winding start end S1 to a winding terminal end E1,

wherein positions of the winding start end S1 and the winding terminal end E1 are different from each other in a tire width direction, and

wherein in a case that a belt incline side is set to a side in which the cord C of the belt ply 6a in the outermost side in the tire diametrical direction among the plurality of belt plies is inclined to the tire peripheral direction CD, at least a part of the ribbon rubber 20 is wound in a posture in which the part is inclined to an opposite side to the belt incline side in relation to the tire peripheral direction CD.

Further, the pneumatic tire of the present embodiment is produced by the following manufacturing method. In other words, the manufacturing method of the pneumatic tire of the present embodiment is a manufacturing method of a pneumatic tire including a belt layer 6 which is provided in a tread portion 3 and is constructed by a plurality of belt plies having cords which are inclined to a tire peripheral direction CD, and a tread rubber 10 which is arranged in an outer side in a tire diametrical direction of the belt layer 6 in the tread portion 3, the method including:

a tread rubber forming step of forming the tread rubber 10 by winding a ribbon rubber 20 around a tire rotating axis continuously from a winding start end S1 to a winding terminal end E1,

wherein the tread rubber forming step differentiates positions of the winding start end S1 and the winding terminal end E1 from each other in a tire width direction WD, and

wherein in a case that a belt incline side is set to a side in which the cord C of the belt ply 6a in the outermost side in the tire diametrical direction among the plurality of belt plies is inclined to the tire peripheral direction CD, the method winds at least a part of the ribbon rubber 20 in a posture in which the part is inclined to an opposite side to the belt incline side in relation to the tire peripheral direction CD.

As mentioned above, since at least a part of the ribbon rubber is wound in the posture in which the part is inclined to the opposite side to the belt incline side in relation to the tire peripheral direction, the force is generated in the direction of cancelling the ply steer, on the basis of the winding posture of the ribbon rubber, and it is possible to suppress the one-sided flow of the tire caused by the ply steer. Further, since the winding start end S1 and the winding terminal end E1 are different in their positions in the tire width direction WD, the structure is preferable in the light of the uniformity. Further, since the winding terminal end is positioned in the tread end portion, the uniformity, for example, the radial runout (PRO) and the radial force variation (RFV) is improved in comparison with the case that the winding terminal end is provided in the tread center portion, and it is possible to improve the high-speed durability.

Particularly, in the present embodiment, in the case that the cord C of the belt ply 6a in the outermost side in the tire diametrical direction extends from the one side WD1 in the tire width direction to the other side WD2 in the tire width direction as the cord C heads for the advance side RO1 from the delay side RO2 in the tire rotating direction RO, the ribbon rubber 20 is wound so that the winding density is higher in the one side WD1 in the tire width direction than in the other side WD2 in the tire width direction.

According to the structure, the force called as the ply steer is generated from the one side WD1 in the tire width direction toward the other side WD2 in the tire width direction in conjunction with the tire rotation. However, since the winding density of the ribbon rubber 20 is higher in the one side WD1 in the tire width direction than in the other side WD2 in the tire width direction, the force called as the conicity is generated in the direction of cancelling the ply steer. Therefore, it is possible to further reduce the ply steer.

Further, according to the present embodiment, since the ribbon rubber 20 is wound from the start point S1 which is positioned in the tread center portion Ce toward the other side WD2 in the tire width direction, is next folded back to the one side WD1 in the tire width direction at the tread end P2 in the other side WD2 in the tire width direction so as to be wound toward the tread end P1 in the one side WD1 in the tire width direction, and is terminated at the tread end portion T2 in the other side WD2 in the tire width direction, the one side in the tire width direction of the tread rubber 10 is formed as the N-th layer structure (N is a natural number which is equal to or more than 1), and the other side in the tire width direction of the tread rubber is formed as the (N+1)th layer structure.

According to the structure, it is possible to appropriately wind the ribbon rubber while differentiating the positions of the winding start end S1 and the winding terminal end E1 of the ribbon rubber 20 in the tire width direction WD. Further, it is possible to obtain the structure in which the winding density is differentiated between the one side WD1 and the other side WD2 in the tire width direction, by adjusting the pitch so that the thickness of the tread rubber 10 is constant, and the tire having the difference in the winding density can be easily manufactured.

Further, in the present embodiment, the ribbon rubber 20 is spirally wound over a whole area in the tire peripheral direction CD in the posture in which the ribbon rubber is inclined to the opposite side to the belt incline side in relation to the tire peripheral direction CD.

According to the structure, since the force of cancelling the ply steer becomes stronger in comparison with the pitch feed winding, it is possible to further suppress the one-side flow of the tire caused by the ply steer.

Further, in the present embodiment, the winding start end S1 and the winding terminal end E1 are away at 180 degrees in the tire peripheral direction, and are arranged in the positional relationship in which the winding start end S1 and the winding terminal end E1 are symmetrical around the tire rotating axis as seen from the tire rotating axis. According to the structure, since the uniformity, for example, a radial force variation (RFV) is improved, and a grounded pressure distribution on the periphery is uniform, it is possible to improve a high-speed durability.

Further, in the present embodiment, the winding terminal end E1 is arranged in the forming position of the main groove 15 which extends in the tire peripheral direction CD. Since the forming position of the main groove 15 is smaller in a rubber thickness and can suppress heat generation at the high-speed rotating time, it is possible to suppress failure caused by the heat generation, and it is possible to further improve the high-speed durability.

### Modified Example of First Embodiment

(1) The moving route of the winding position of the ribbon rubber 20 may be reversed laterally as shown in FIG. 12 in addition to that in FIG. 11.

(2) In the present embodiment, the nonconductive rubber is used for the ribbon rubber 20, however, a conductive rubber may be used, or a ribbon rubber obtained by overlapping the non-conductive rubber and the conductive rubber may be used. Further, FIG. 2 shows the example which used one ribbon rubber forming device 30, however, a so-called two-shot type using a plurality of ribbon rubber forming devices 30 may be employed.

(3) An optional moving route can be employed as long as the one side WD1 in the tire width direction of the tread rubber 10 can be formed as the N-th layer structure, and the other side WD2 in the tire width direction can be formed as the (N+1)th layer structure. For example, as shown in FIG. 13, the one side WD1 in the tire width direction of the tread rubber 10 may be formed as a double layer structure, and the other side WD2 in the tire width direction of the tread rubber 10 may be formed as a triple layer structure.

It is possible to apply the structure employed in each of the embodiments to the other optional embodiment. The particular structure of each of the portions is not limited to the embodiments mentioned above, but can be variously modified within a range which does not deviate from the scope of the present invention.

What is claimed is:

1. A pneumatic tire comprising:
a belt layer which is provided in a tread portion and is constructed by a plurality of belt plies having cords which are inclined to a tire peripheral direction; and
a tread rubber which is arranged in an outer side in a tire diametrical direction of the belt layer in the tread portion,
wherein the tread rubber is formed by a ribbon rubber which is wound around a tire rotating axis continuously from a winding start end to a winding terminal end,
wherein positions of the winding start end and the winding terminal end are different from each other in a tire width direction, and
wherein in a case that a belt incline side is set to a side in which the cord of the belt ply in the outermost side in the tire diametrical direction among the plurality of belt plies is inclined to the tire peripheral direction, at least a part of the ribbon rubber is wound in a posture in which the part is inclined to an opposite side to the belt incline side in relation to the tire peripheral direction.

2. The pneumatic tire according to claim 1, wherein in the case that the cord of the belt ply in the outermost side in the tire diametrical direction extends from one side in the tire width direction to the other side in the tire width direction as the cord heads for an advance side from a delay side in the tire rotating direction, the ribbon rubber is wound so that a winding density is higher in the one side in the tire width direction than in the other side in the tire width direction.

3. The pneumatic tire according to claim 1, wherein the ribbon rubber is wound from a start point which is positioned at a tread end portion in the other side in the tire width direction toward the one side in the tire width direction, is next folded back to the other side in the tire width direction at a tread end in the one side in the tire width direction so as to be wound toward a tread end in the other side in the tire width direction, and is next folded back to the one side in the tire width direction at the tread end in the other side so as to be wound to an end point which is positioned in a tread center portion, whereby the one side in the tire width direction of the tread rubber is formed as a double layer structure, and the other side in the tire width direction of the tread rubber is formed as a triple layer structure.

4. The pneumatic tire according to claim 1, wherein the ribbon rubber is spirally wound over a whole area in the tire peripheral direction in a posture in which the ribbon rubber is inclined to an opposite side to the belt incline side in relation to the tire peripheral direction.

5. A pneumatic tire comprising:
a belt layer which is provided in a tread portion and is constructed by a plurality of belt plies having cords which are inclined to a tire peripheral direction; and
a tread rubber which is arranged in an outer side in a tire diametrical direction of the belt layer in the tread portion,
wherein the tread rubber is formed by a ribbon rubber which is wound around a tire rotating axis continuously from a winding start end to a winding terminal end,
wherein the winding start end is positioned in a tread center position and the winding terminal end is positioned in a tread end portion, whereby positions of the winding start end and the winding terminal end are different from each other in a tire width direction, and
wherein in a case that a belt incline side is set to a side in which the cord of the belt ply in the outermost side in the tire diametrical direction among the plurality of belt plies is inclined to the tire peripheral direction, at least a part of the ribbon rubber is wound in a posture in which the part is inclined to an opposite side to the belt incline side in relation to the tire peripheral direction.

6. The pneumatic tire according to claim 5, wherein in the case that the cord of the belt ply in the outermost side in the tire diametrical direction extends from one side in the tire width direction to the other side in the tire width direction as the cord heads for an advance side from a delay side in the tire rotating direction, the ribbon rubber is wound so that a winding density is higher in the one side in the tire width direction than in the other side in the tire width direction.

7. The pneumatic tire according to claim 5, wherein the ribbon rubber is wound from a start point which is positioned in a tread center portion toward the other side in the tire width direction, is next folded back to the one side in the tire width direction at a tread end in the other side in the tire width direction so as to be wound toward a tread end in the one side in the tire width direction, and is terminated at the tread end portion in any of the one side in the tire width direction and the other side in the tire width direction, whereby the one side in the tire width direction of the tread rubber is formed as an N-th layer structure (N is a natural number which is equal to or more than 1) , and the other side in the tire width direction of the tread rubber is formed as an (N+1)th layer structure.

8. The pneumatic tire according to claim 5, wherein the ribbon rubber is spirally wound over a whole area in the tire peripheral direction in a posture in which the ribbon rubber is inclined to an opposite side to the belt incline side in relation to the tire peripheral direction.

9. A manufacturing method of a pneumatic tire comprising a belt layer which is provided in a tread portion and is constructed by a plurality of belt plies having cords which are inclined to a tire peripheral direction, and a tread rubber which is arranged in an outer side in a tire diametrical direction of the belt layer in the tread portion, the method comprising:
a tread rubber forming step of forming the tread rubber by winding a ribbon rubber around a tire rotating axis continuously from a winding start end to a winding terminal end,
wherein the tread rubber forming step differentiates positions of the winding start end and the winding terminal end from each other in a tire width direction, and
wherein in a case that a belt incline side is set to a side in which the cord of the belt ply in the outermost side in the tire diametrical direction among the plurality of belt plies is inclined to the tire peripheral direction, the method winds at least a part of the ribbon rubber in a posture in which the part is inclined to an opposite side to the belt incline side in relation to the tire peripheral direction.

10. The manufacturing method of the pneumatic tire according to claim 9, wherein the tread rubber forming step arranges the winding start end in a tread center portion and arranges the winding terminal end in a tread end portion.
